(19) United States
(12) Patent Application Publication
(10) Pub. No.: US 2005/0011342 A1
(43) Pub. Date: Jan. 20, 2005

(54) Musical instrument transducer

(76) Inventor: Lawrence R. Fishman, Winchester, MA (US)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/622,381

(22) Filed: Jul. 18, 2003

(51) Int. Cl. G10H 3/14

(52) U.S. Cl. 84/730

(57) ABSTRACT

A plurality of force sensing transducer elements are enclosed in a stringed musical instrument bridge height adjuster, designed to be installed as one of a pair of height adjusters in the legs of the bridge. The transducers are disposed to allow rotation of the adjuster to control how the modes of vibration in the bridge affect the transducers, thus allowing the player to adjust the tonal response of the transducers to the instrument and to their own sound preference. An inline jack-plug pair allows the output cable of the transducer to be quickly disconnected and reconnected to avoid straining or tangling the cable while adjusting the tone and the bridge height.

### FIELD OF THE INVENTION

The present invention relates generally to musical instrument transducers for use with stringed musical instruments employing a bridge for a portion of their string support. More particularly, the invention pertains to a stringed instrument such as a bass violin.

### STATEMENT REGARDING FEDERALLY SPONSORED RESEARCH OR DEVELOPMENT

N/A

### BACKGROUND OF THE INVENTION

There are numerous musical instrument transducers in existence, and several of them have been designed specifically in an attempt to solve the problem of producing an accurate electrical replica of the sound of an instrument such as a bass violin. A conventional musical instrument transducer of the force sensing transducer type for use with a bass violin is disclosed in U.S. Pat. No. 4,356,754 issued Nov. 2, 1982 and entitled Musical Instrument Transducer. The conventional transducer described herein has a plurality of piezoelectric elements attached with clips onto one of the faces of the bridge of the instrument, and in the preferred embodiment an output cable connected to a jack and mounting plate that is secured to the strings between the bridge and the tailpiece. This style of transducer allows good reproduction of the sound of plucked strings, but is deficient at reproducing the sound of bowed strings. Another drawback includes the risk of the transducer being dislodged and possibly damaged with handling or while in transit. This style of construction leaves both the piezoelectric elements and their cable connections exposed and vulnerable to damage. Additionally, there is a need to attach a ground wire to all of the strings to prevent their acting as antennae for electromagnetic interference, while requiring no irreversible modifications to the instrument.

It would therefore be desirable to have a transducer that allows accurate reproduction of both plucked and bowed strings, adjustibility of the tonal characteristics, that is less at risk of being dislodged or damaged, is feedback resistant, and is fully shielded from electromagnetic interference.

### BRIEF SUMMARY OF THE INVENTION

In accordance with the present invention, a musical instrument transducer of the force sensing transducer type is disclosed that is formed in the shape of a bass violin bridge height adjuster, and that allows the position of the internal transducer elements to be rotationally altered to optimize the sound of the pickup on each specific instrument.

While the process of installing this transducer requires the bridge to be modified, it is a modification already present on many bridge-equipped stringed instruments, one that is considered very standard, doesn't impair the non-amplified function of the instrument, and allows regular height adjuster wheels to be installed if the transducer should be removed. In addition, this style of transducer does not require mechanical re-biasing after bridge height adjustment, as some other types do.

In a preferred embodiment, the presently disclosed transducer assembly is configured to contain four piezoelectric transducer disks arrayed in a circle, inside an enclosure that has the outer shape of a bass violin bridge height adjuster. The enclosure is composed of a cylindrical base with a threaded post, and a cover with a non-threaded cylindrical post. The base and cover are mechanically and electrically joined with an electrically conductive adhesive to ensure good electromagnetic shielding continuity when the enclosure is grounded. Within the enclosure, an interior or bottom surface of the cover is in physical contact with the piezoelectric transducer disks. Thus, the ground path extends from the upper surface of the transducer disks through the cover, the electrically conductive adhesive, and the base to a cable connected thereto. The transducer disks themselves are mounted on a disk of copper-clad circuit board with an electrically conductive adhesive to complete the electrical path between the bottom of the transducer disks, across the metalized circuit board, and to a conductor of a connected cable. A rigid, electrically isolating spacer is disposed between the transducer disks. This disk assembly sits on a resilient, insulating support inside the enclosure. A center conductor of a coaxial cable makes contact with the copper-clad portion of the circuit board, and an outer shield of the cable makes contact with the enclosure. The cable is terminated in this preferred embodiment at a jack-plug pair to allow quick disconnection and reconnection when the enclosure is rotated, thereby preventing tangling or damage to the cable.

In a presently preferred embodiment, the lowest frequency string on the instrument is the E string, and the leg on that side of the bridge will be referred to as the bass leg. Additionally in this embodiment, the highest frequency string on the instrument is the G string, and the leg on that side of the bridge will be referred to as the treble leg.

Inside the body of a bass violin, there are two particular structures below the legs of the bridge. Under the treble leg there is a support known as a sound post, mechanically connecting the top and back parts of the body of the instrument. Under the bass leg, attached to the inside of the top part of the body, there is a longitudinal rib called the bass bar, a structural support that is also used to tune the response of the instrument. The rigidity of the sound post and the relative flexibility of the bass bar cause the bridge to effectively pivot around the sound post in response to the motion of the strings. Thus there is a major advantage to installing a force sensing mechanism in the bass leg of the bridge, where there is a much greater mechanical excursion. Bowing and plucking the strings of an instrument with this bridge support configuration will each give different modes of vibration.

In a presently preferred embodiment, the transducer is installed by cutting a section out of the bass leg of the bridge, drilling holes into both leg sections for the posts, threading one of the holes, attaching the transducer into the leg sections, performing a matching set of actions on the treble leg with a regular bridge height adjuster, reinstalling the bridge on the instrument, and attaching the output connector through a signal cable to an amplifier or other signal processing electronic device.

Additionally in the preferred embodiment, the resilient support is made of a material such as silicone rubber selected for a combination of thickness and durometer that distributes pressure evenly on the transducer disks and prevents over-clamping due to extreme height adjustment, thus preserving the dynamic range of the transducers. The resiliency of the material results in a self-aligning support which further limits the effects of over-clamping and serves to keep the transducers in an optimal range of clamping forces for maximum response. A typical combination would be a thickness in the range of 0.020″ to 0.040″, with a durometer in the range of 40 to 60 Shore A.

The process of hole-drilling, threading and installation of the bridge height adjusters is well known to those skilled in the art, and may be found in the installation instructions in any standard after-market bass bridge height adjuster.

Other features, functions, and aspects of the invention will be evident from the Detailed Description of the Invention that follows.

### BRIEF DESCRIPTION OF THE SEVERAL VIEWS OF THE DRAWING

The invention will be more fully understood with reference to the following Detailed Description of the Invention in conjunction with the drawings of which:

FIG. 1 shows a perspective view of a bass violin with a force sensing transducer according to the present disclosure installed in the bridge;

FIG. 2 shows a partial section view of a bass violin bridge with the force sensing transducer of FIG. 1 and a standard adjuster;

FIG. 3 shows a side view of a bass violin bridge with the force sensing transducer of FIG. 1 and with a plug and jack pair shown disconnected;

FIG. 4 shows a section view through the force sensing transducer of FIG. 1;

FIG. 5 shows a perspective, exploded view of the force sensing transducer of FIG. 1; and

FIG. 6 shows a section view of an alternative embodiment of the force sensing transducer of FIG. 1.

### DETAILED DESCRIPTION OF THE INVENTION

A musical instrument transducer of the force sensing transducer type is disclosed and shown mounted in the leg of the bridge of a bass violin.

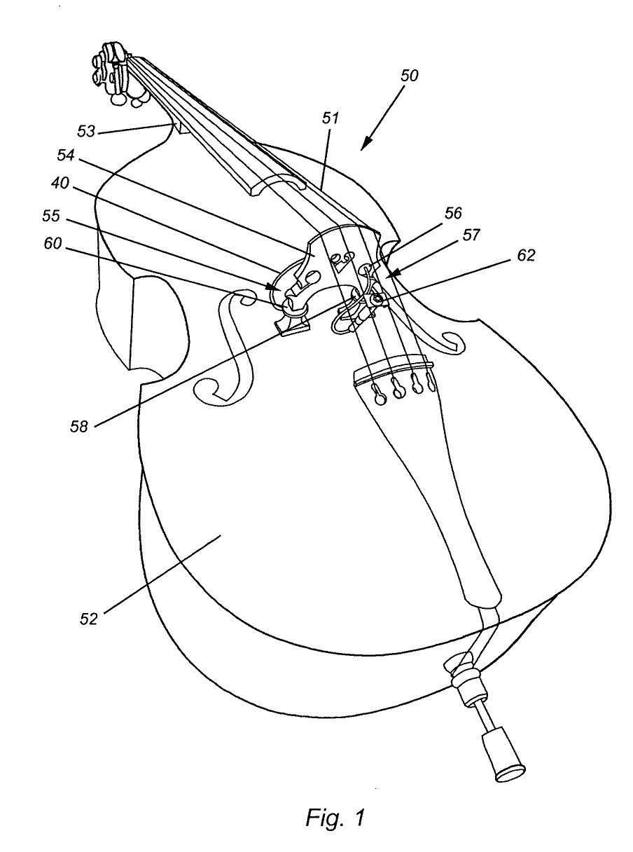

As described above, in a preferred embodiment, there is shown in FIG. 1 a stringed musical instrument in the form of a bass violin 50 comprising a body 52, a neck 53, a bridge 54, and a plurality of strings 51. Mounted in the bass leg 55 of the bridge 54 is a force sensing transducer 60, and mounted in the treble leg 57 of the bridge 54 is a commonly available height adjuster 58. Further shown is a coaxial cable 40 electrically connecting the force sensing transducer 60 to the jack and plug assembly 62, and a foam rubber or neoprene isolation plug 56 that secures the coaxial cable 40 relative to the bridge 54.

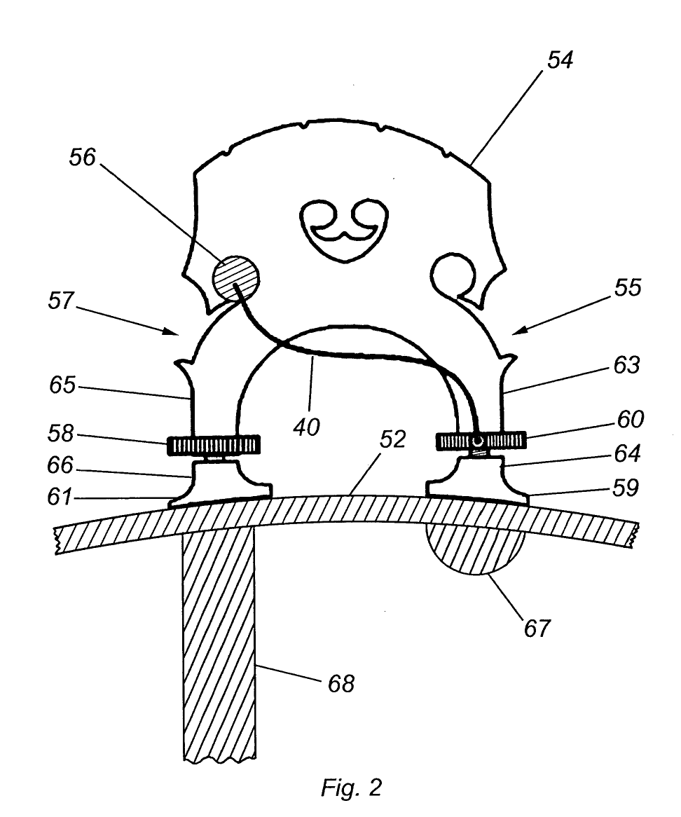

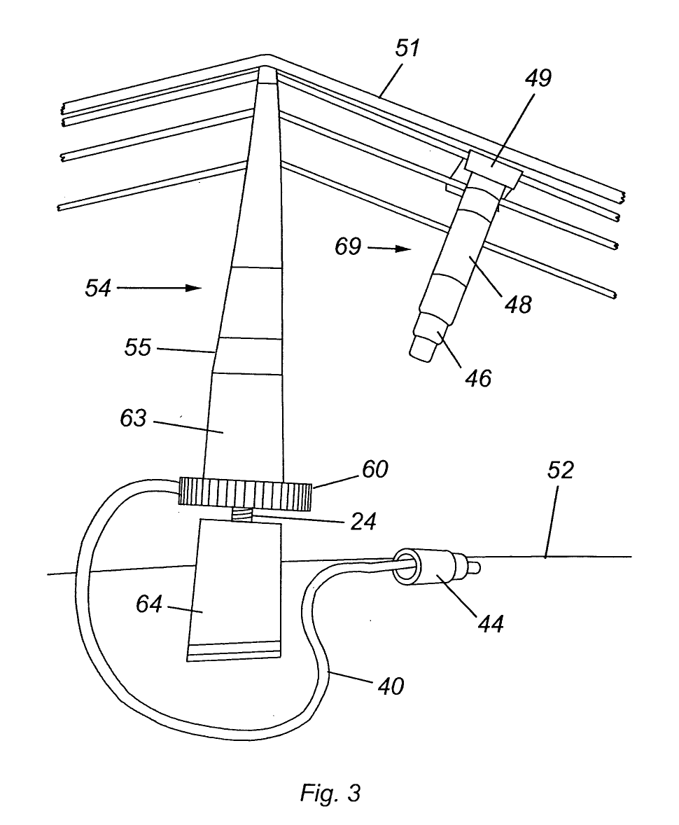

A more detailed view of the mounting scheme of a presently preferred embodiment is shown in FIG. 2, including the location of both the bass bar 67 and the sound post 68. FIG. 3 depicts the unplugged jack subassembly 69, where the RCA plug 44 at the end of the coaxial cable 40 is detached from the subassembly, which includes the RCA jack 46 electrically and mechanically connected to the ¼″ jack 48, and the mounting plate 49. In FIG. 3, the cable 40 has also been removed from the foam rubber isolation plug 56. This unplugged form of the jack and plug assembly 62 allows easy and quick connection and disconnection of the cable 40 in such a way as to facilitate the rotation of the force sensing transducer 60 without tangling or straining the cable 40.

It is shown in FIG. 1, FIG. 2 and FIG. 3 how the force sensing transducer 60 is positioned between the upper bass leg section 63 and the lower bass leg section 64, and the height adjuster 58 is positioned between the upper treble leg section 65 and the lower treble leg section 66. The lower leg sections terminate in the bass and treble feet 59, 61, respectively. These feet rest on the top, outer surface of the body 52. For purposes of the description of a presently preferred embodiment, the feet 59, 61 are considered to be portions of the lower leg sections 64, 66, respectively.

Each of the legs is divided into an upper and a lower section by a process of making two cuts to remove an intermediate section of each leg, the section having a thickness slightly greater than the thickness of an enclosure 22 of the transducer 60 or the main body of the height adjuster 58 (not including the upper and lower vertical projections). Holes are drilled into both remaining sections and one of the holes in each leg is threaded. The force sensing transducer 60 and the height adjuster 58 are then installed into the leg section pairs prior to re-installing the bridge on the instrument.

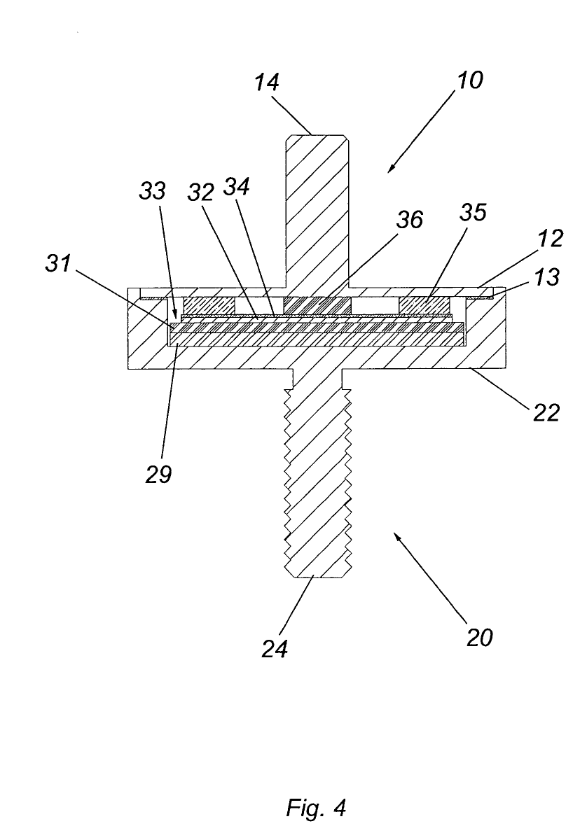

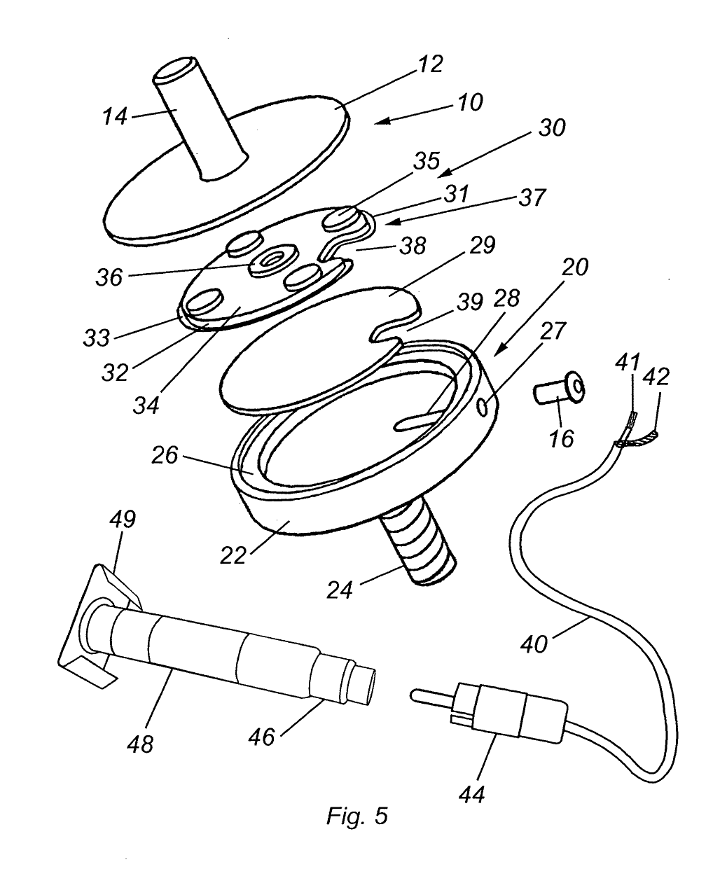

FIG. 4, in which the vertical scale has been exaggerated for better clarity, and FIG. 5 show the enclosure 22 formed from the cover 10 and the base 20. The lower leg sections 64, 66 are threaded, and the enclosure 22 shape of the force sensing transducer 60 is identical to the shape of the height adjuster 58. With component detail shown in FIG. 4 and FIG. 5, this allows the threaded post 24 of the base 20 and its counterpart on the height adjuster 58 to selectively regulate the height of the bridge 54. Likewise, the cover 10 has a cylindrical member 14 inserted into the bottom of the upper bass leg section 63, and a disk 12 typically of thickness approximately in the range of 0.020″ to 0.060″ bearing against the bottom of the upper bass leg section 63, establishing a pathway for the vibration of the strings 51 to travel through the bridge 54 and into the force sensing transducer 60.

It is preferred that the hole formed in the upper bass leg section 63 be deep enough such that the entire cylindrical member 14 of the cover 10 fits inside. It is also preferable that, once the cylindrical member 14 of the cover 10 is installed in the upper bass leg section 63, the area of contact between the exposed end of the upper bass leg section 63 and the disk 12 of the cover 10 be maximized. Such an arrangement maximizes the vibrational force coupled into the transducer 60 through the disk 12 of the cover 10.

The disk 12 of the cover 10, in turn, bears on a plurality of circularly-disposed transducer elements 35 within the enclosure 22. Forces resulting from vibrations in the instrument cause the disk 12 of the cover 10 to act as a diaphragm, whereby mechanical deflection of the disk 12 results in a change in the compression to which the transducer disks are subjected. Ultimately, it is the electrical response of the passive transducers 35 to the dynamically changing compression which is used as an instrument-characterizing signal.

The transducer cover 10 and base 20, preferably made of a metal such as aluminum, are bonded together with a conductive adhesive 13 such as a silver-filled epoxy deposited within an internal cylindrical recess 26 therebetween. This allows the enclosure 22 formed by the assembled combination of base 20 and cover 10 to act as an environmental and electromagnetic shield for the transducer elements 35 within.

Vibration-induced flexure of the disk 12 is limited by a rigid spacer 36, here disposed between the plurality of transducer elements 35, typically lower in height than the transducer elements 35 by an amount in the range of 0.002″ to 0.015″. This flexure limiting controls the range of mechanical bias placed upon the transducer elements 35, and thus aids in controlling the quality of the output signal from them.

A printed circuit (PC) board assembly 30 as shown in FIG. 5 comprises the plurality of transducer elements 35, the rigid spacer 36, a conductive adhesive film 34, and a disk preferably made of copper-clad circuit board 37. The disk of copper-clad circuit board 37 is preferably comprised of an electrically insulating disk 31 with a lamination of copper 32 on one side, and an insulating border 33 by which the diameter of the lamination 32 is smaller than the diameter of the insulating disk 31 by at least 0.010″. The PC board assembly 30 is positioned upon a resilient support 29 within the enclosure 22. In the embodiment shown, there is a first slot 38 in the PC board assembly 30 and a second slot 39 in the resilient support 29 for providing mechanical clearance for the coaxial cable 40 including both the signal wire 41 and the shield 42 contained within it. Furthermore, the enclosure 22 contains a wire groove 28 in a bottom surface thereof for clearance of the coaxial cable 40. The coaxial cable 40 enters the wire groove of the enclosure 22 through an eyelet 16 which is pressed into a hole 27. Once inserted, the shield 42 is soldered or otherwise electrically attached to the case, typically the eyelet 16, to establish a ground connection, and the signal wire 41 is soldered to the lamination of copper 32 to make electrical contact with the plurality of transducer elements 35 through the conductive adhesive film 34. Mechanical engagement (not shown) of the cable 40 within the enclosure 22 is also provided. The upper faces of the transducer elements 35 are grounded by contact with the underside of the disk 12.

As the strings 51 are plucked or bowed, they transmit time-varying mechanical energy into the bridge 54 and thus down into the legs 55, 57. The treble leg 57 is limited in its mechanical response by the sound post 68, while the bass leg 55 has much more freedom of mechanical response. The vibrations in the upper bass leg section 63 are transmitted through the disk 12 of the cover 10 into the transducer elements 35, with the overall mechanical excursion of the disk 12 being limited by the rigid spacer 36. The electrical outputs of the transducer elements 35 are transmitted through the conductive adhesive film 34 and summed through the lamination of copper 32, which acts as a common terminal for them. Under the PC board assembly, the resilient support 29 serves to distribute pressure evenly across the transducers and to prevent over-clamping.

Rotating the force sensing transducer 60 relative to the bridge 54 causes the orientation of the transducer elements 35 to change relative to the transmitted modes of vibration in the bridge 54 and the upper bass leg section 63, thus giving the player the ability to optimize the sound of the instrument for a particular style of playing and tonal preferences. Rotation of the force sensing transducer also enables bridge height adjustment as in the case of the standard height adjusting member 58 in the treble leg 57.

In another embodiment of the invention, the instrument that the presently disclosed transducer is mounted on may have fewer or more than the four strings illustrated here.

Having described the above illustrative embodiments, other alternative embodiments or variations may be made. For example, such alternative embodiments of the force sensing transducer may include having the mechanism installed without threading on the cylindrical member 14 and without an adjuster in the other leg, thus retaining all of the sensing functionality but without any height adjustment.

Another alternate embodiment has the transducer built as an integral part of the leg of the bridge. Such a fixed embodiment sacrifices the rotational tone adjustment capability and height adjustment capability to gain mechanical simplicity. In this embodiment, the transducer may be disposed within a leg of the bridge, or provided as a foot of a bridge leg.

Alternative embodiments have fewer or more than four transducer elements, such elements being arranged circularly as described above or in a different pattern inside the enclosure, depending upon the application, thus yielding different sound characteristics and different sound adjustment capabilities.

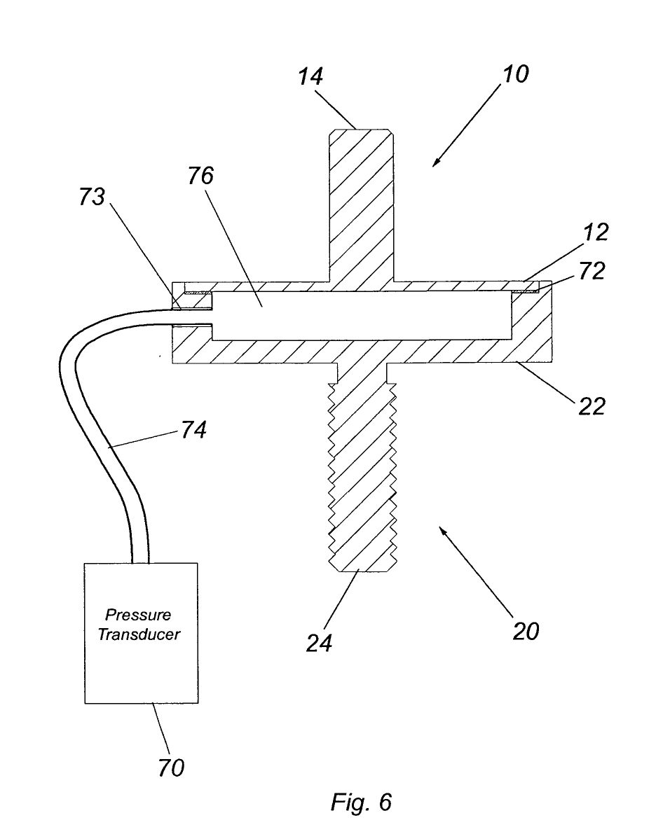

A further embodiment of the presently disclosed invention substitutes a fluid for the piezoelectric transducers 35 disclosed above. In this embodiment, shown in FIG. 6, the enclosure 22 is formed by securing the base 20 and cover 10 together to form a fluid-tight seal. To provide such a seal, adhesive, a resilient seal or O-ring, or other sealing means 72 may be employed. Inside the container, a chamber 76 for the fluid takes the place of the circuit board 37, the piezoelectric transducer elements 35, the spacer 36, and the resilient support 29. The chamber 76 is formed by the interior surfaces of the disk 12 and the enclosure 22 in one simple embodiment, and by a fluid-bearing bladder in another. Gas or liquid may be employed as the fluid. Instead of the coaxial cable 40, a fluid-tight conduit 74 is in communication with the interior of the fluid chamber 76 within the enclosure 22 and interfaces to an external pressure transducer 70 which converts instantaneous pressure or time-varying pressure differentials to electrical signals. Preferably, the fluid-tight conduit 74 interfaces to the enclosure 22 through a conduit seal 73, which may be an adhesive, a resilient ring, or threads formed on the conduit 74 end and in the enclosure. The conduit length is minimized to avoid damping effects resulting from conduit wall resiliency. Alternatively, a pressure transducer could be disposed in conjunction with the enclosure 22 to avoid such signal losses, with appropriate cabling extending from the instrument.

In a further embodiment of the fluid-based transducer of FIG. 6, the movement of the diaphragm or cover 12 may be limited in a controlled fashion by a rigid spacer, such as the rigid spacer 36 shown in FIG. 5, positioned within the chamber, serving to prevent over-extension of the diaphragm and possible operation of the pressure transducer outside of an optimal range. Further diaphragm movement control may be gained by combining the rigid spacer with a resilient support material, such as the support 29 shown in FIG. 5, thus allowing the movement of the diaphragm to encounter a more gradual limit.

It will further be appreciated by those of ordinary skill in the art that modifications to and variations of the above-described musical instrument transducer may be made without departing from the inventive concepts disclosed herein. Accordingly, the invention should not be viewed as limited except as by the scope and spirit of the appended claims.

1. A transducer assembly for a stringed musical instrument having a legged bridge for supporting strings, comprising:
an enclosure having a cover and base, each having top and bottom surfaces, the cover and base enclosing a volume therebetween;
a top projection extending from the top surface of the cover;
a bottom projection extending from the bottom surface of the base; and
a transducer at least partially disposed within the volume enclosed by the cover and base and adapted for generating an electrical signal in response to forces applied to the enclosure,
wherein the transducer assembly is configured to be disposed between first and second portions of a first bridge leg.

2. The transducer assembly of claim 1, wherein the top projection is configured to be disposed within a corresponding bore in the first portion of the first bridge leg.

3. The transducer assembly of claim 2, wherein the top projection and the corresponding bore in the first portion of the bridge leg are dimensioned such that the first portion of the first bridge leg is brought into contact with the top surface of the cover when the top projection is disposed within the corresponding bore in the first portion of the first bridge leg.

4. The transducer assembly of claim 1, wherein the bottom projection is configured to be disposed within a corresponding bore in the second portion of the first bridge leg.

5. The transducer assembly of claim 4, wherein the bottom projection is threaded and the bore in the second portion of the first bridge leg has a complimentary thread, whereby the bottom projection is selectively positionable within the corresponding bore in the second portion of the first bridge leg through rotation of the transducer assembly.

6. The transducer assembly of claim 5, further comprising at least one electrical conductor in communication with and extending beyond the enclosure for selective engagement with external amplifying equipment.

7. The transducer assembly of claim 6, further comprising a jack-plug pair for enabling selective engagement of the at least one electrical conductor with the external amplifying equipment.

8. The transducer assembly of claim 1, wherein the transducer is in contact with the bottom surface of the cover and is adapted to convert a force applied by the cover to the transducer into the electrical signal.

9. The transducer assembly of claim 8, further comprising plural transducers disposed with the enclosure.

10. The transducer assembly of claim 9, further comprising a circuit board for supporting the transducers in contact with the bottom surface of the cover.

11. The transducer assembly of claim 10, further comprising a spacer disposed upon the circuit board for limiting the forces applied by the cover to the transducers.

12. The transducer assembly of claim 10, further comprising a resilient support for enabling self-alignment of the transducers and circuit board with respect to the cover.

13. The transducer assembly of claim 1, wherein the transducer comprises a fluid-tight volume enclosed by the cover and base for converting forces applied by the cover into corresponding pressure differentials within the volume.

14. The transducer assembly of claim 13, further comprising a fluid-tight conduit, in communication with the volume enclosed by the cover and base, and an external transducer, in communication with the fluid-tight conduit, the external transducer for converting pressure differentials in the volume to the electrical signal.

15. The transducer assembly of claim 1, further comprising a bridge height adjuster disposed within first and second portions of a second bridge leg.

16. A multifunction transducer for a stringed musical instrument having a bridge, comprising:
a height adjuster disposed in conjunction with a leg of the bridge, and
a transducer assembly disposed within the height adjuster for reacting to forces transmitted through the bridge leg to the height adjuster by providing an electrical signal reflective of the forces.

17. The multifunction transducer of claim 16, wherein the transducer assembly comprises a substrate and at least one transducer disposed thereon, the transducer being in physical contact with a portion of the first height adjuster whereby forces transmitted to the height adjuster result in force differentials at the surface of the transducer.

18. The multifunction transducer of claim 16, further comprising an electrically conductive cable in communication with the height adjuster and the transducer for conveying signals reflective of the electrical response from the transducer to the forces applied by the height adjuster on the transducer.

19. A system for converting forces generated in a stringed musical instrument having a bridge into electrical signals reflective of the forces, comprising:
a diaphragm in physical communication with at least a portion of the bridge;
a transducer assembly in physical communication with the diaphragm; and
an enclosure for supporting the system in conjunction with the bridge.

20. The system of claim 19, wherein the enclosure comprises top and bottom projections adapted for insertion into complimentary bores in the bridge, one of the projections being threaded along with the respective bore, thereby enabling the enclosure to function as a height adjuster.

21. The system of claim 19, wherein the diaphragm comprises a cover for the enclosure, the top projection extending from the diaphragm.

22. The system of claim 19, wherein the transducer assembly comprises plural piezoelectric transducers.

23. The system of claim 19, wherein the transducer assembly comprises:
a fluid-tight chamber containing a fluid in communication with the diaphragm;
a fluid-tight conduit in communication with the fluid-tight chamber; and
a transducer in communication with the fluid-tight conduit, wherein the transducer is adapted for converting a pressure differential in the fluid within the fluid-tight chamber and conduit, resulting from deformation of the diaphragm due to forces generated within the musical instrument, to an electrical signal.

24. A method of installing a transducer assembly in a stringed musical instrument having a bridge with two legs, comprising:
removing the bridge from the stringed musical instrument;
removing an intermediate leg section of each bridge leg to realize the bridge with two attached upper leg sections and a lower leg section associated with each upper leg section;
reinstalling the bridge on the stringed musical instrument with a height adjuster intermediate one lower leg section and the respective upper leg section and a combination height adjuster and transducer assembly intermediate the other lower leg section and the respective upper leg section, the combination height adjuster and transducer assembly comprising at least one transducer; and electrically connecting the combination height adjuster and transducer assembly to an electrical signal amplifier,
whereby forces generated within the stringed musical instrument are conveyed to the combination height adjuster and transducer assembly and are converted to electrical signals reflective thereof.

25. The method of claim 24, further comprising the step of rotating the combination height adjuster and transducer assembly in order to alter the response of the transducer to the forces generated within the stringed musical instrument.

26. The method of claim 25, wherein rotating the combination height adjuster and transducer results in the adjustment of the height of the bridge with respect to the stringed musical instrument.
